(19) United States
(12) Patent Application Publication
(10) Pub. No.: US 2017/0171405 A1
(43) Pub. Date: Jun. 15, 2017

(54) SYSTEM AND METHOD FOR INTELLIGENT ENTRY OF FAX NUMBERS

(71) Applicants: Kabushiki Kaisha Toshiba, Minato-ku (JP); Toshiba TEC Kabushiki Kaisha, Shinagawa-ku (JP)

(72) Inventors: Marianne Kodimer, Huntington Beach, CA (US); Jia Zhang, Irvine, CA (US)

(21) Appl. No.: 15/376,125

(22) Filed: Dec. 12, 2016

Related U.S. Application Data
(60) Provisional application No. 62/265,476, filed on Dec. 10, 2015.

(51) Int. Cl. H04N 1/00; H04N 1/32; G06F 3/0488; H04M 3/44; H04M 3/42

(52) U.S. Cl. CPC H04N 1/00506; H04M 3/44; H04M 3/42102; G06F 3/0488; H04N 1/00411; H04N 1/32069; H04N 1/00042; H04N 1/0009; H04N 2201/0094; H04N 2201/3209

(57) ABSTRACT

A system and method for populating fax recipient information on multifunction peripherals includes a touchscreen and a processor configured to generate user interface screens and receive user input from the touchscreen. The processor monitors the touchscreen for user entry of fax recipient information. The processor determines when there is a match between user entered information and contact information from an address book. When there is a match, the processor populates additional fax recipient information using the contact information. When there is no match of an entered fax number with a contact, the processor enters the fax number as the name of fax recipient. The processor monitors the touchscreen for user input that overwrites the processor populated fax recipient information, or a user command to add a fax recipient to a fax recipient list. The processor faxes a document to each fax recipient on the fax recipient list.

### REFERENCE TO RELATED APPLICATIONS

This application claims the benefit of U.S. Provisional Patent Application No. 62/265,476 filed Dec. 10, 2015 and titled “INTELLIGENT ENTRY FOR FAX NUMBER”, which is herein incorporated by reference.

### TECHNICAL FIELD

This application relates generally to interfaces for entering, and automatically populating, fax recipient information on document processing devices. The application relates more particularly to the operation of multifunction peripherals having an interface for accepting user input of intended fax recipients and retrieving additional fax recipient information based on contact information stored in an address book.

### BACKGROUND

Document processing devices include printers, copiers, scanners, fax machines, and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, devices are frequently shared or monitored by users or technicians via a data network. MFPs, while moveable, are generally maintained in a fixed location. A user may approach an MFP for purposes such as faxing from paper or electronic documents. Paper documents may be fed into a scanner for copying or faxing. Electronic documents may be on a portable data device, such as a CD, DVD or flash memory. Print outs may be made wirelessly from a portable digital device, such as a smartphone, tablet, or laptop computing device. Users may also send document processing jobs, such as a print request, to one or more networked devices. In a typical shared device setting, one or more workstations are connected via a network. When a user wants to print a document, an electronic copy of that document is sent to a document processing device via the network. The user may select a particular device when several are available. The user then walks to the selected device and picks up their job or waits for the printed document to be output. When a user wants to fax a document, the user generally walks to a device with the document to be faxed and performs operations on the user interface that instructs the device to fax the document to one or more recipients. In these types of situations, users approach an MFP and control it directly.

MFP control is via a user interface, such as with switches, a keyboard, touchscreen, mouse, trackball or the like. When sending a fax from an MFP to a recipient, a user typically enters the telephone number of the receiving fax machine and instructs the MFP to commence faxing the document. However, manual entry of telephone numbers does not take advantage of new modalities available to network connected MFP devices.

### SUMMARY

In accordance with an example embodiment of the subject application, a system and method for populating fax recipient information includes a user interface that includes a display and an input, such as a touchscreen interface, for receiving fax recipient information from a user, a memory for storing an associated fax recipient list, and processor. The processor generates the user interface screen on the display which includes a list of fax recipients, a fax number entry field and a name entry field. The processor monitors the input of the user interface for user input of fax recipient information. The processor determines when received fax recipient information at least partially matches information associated with one or more contacts of an address book, such as a locally stored address book in the memory or a remote network accessible database of contacts. When the processor determines that there is a match with a contact, the processor populates other fields, such as the fax number field or the name field, with information of the matching contact. When the processor determines that there is no match, such as when a fax number is entered by a user that is not associated with any contact in the address book, then the processor populates the name field with the entered fax number. A user can overwrite the processor populated information. A user then instructs the processor to add the fax recipient to a list of fax recipients. A user can also select fax recipients from the list of contacts in the address book. The processor can complete a document processing operation, such as faxing a document to each fax recipient on the list, in accordance with received instructions from the user.

### BRIEF DESCRIPTION OF THE DRAWINGS

Various embodiments will become better understood with regard to the following description, appended claims and accompanying drawings wherein:

FIG. 1 is an example embodiment of a multifunction peripheral according to an embodiment of the disclosure;

FIG. 2 is an example embodiment of components of a multifunction peripheral according to an embodiment of the disclosure;

FIG. 3 is an example embodiment of a first user interface screen of a multifunction peripheral according to an embodiment of the disclosure;

FIG. 4 is an example embodiment of a second user interface screen of a multifunction peripheral according to an embodiment of the disclosure;

FIG. 5 is an example embodiment of a third user interface screen of a multifunction peripheral according to an embodiment of the disclosure;

FIG. 6 is an example embodiment of a fourth user interface screen of a multifunction peripheral according to an embodiment of the disclosure;

FIG. 7 is an example embodiment of a fifth user interface screen of a multifunction peripheral according to an embodiment of the disclosure;

FIG. 8 is an example embodiment of a sixth user interface screen of a multifunction peripheral according to an embodiment of the disclosure;

FIG. 9 is an example embodiment of a seventh user interface screen of a multifunction peripheral according to an embodiment of the disclosure;

FIG. 10 is an example embodiment of a eighth user interface screen of a multifunction peripheral according to an embodiment of the disclosure;

FIG. 11 is an example embodiment of a ninth user interface screen of a multifunction peripheral according to an embodiment of the disclosure; and

FIG. 12 is a flowchart of operations of an example embodiment of a multifunction peripheral according to an embodiment of the disclosure.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

As noted above, MFP devices can be used to send faxes to other fax machines. The MFP user interface allows users to enter the telephone numbers of one or more receiving fax machines. A network connected MFP enables new modalities for obtaining, retrieving, and/or saving identifying information associated with receiving fax machines. Identifying information can include, but is not limited to, the telephone number for connecting to a receiving fax machine, a name associated with the receiving fax machine, a user associated with the receiving fax machine, address information associated with the receiving fax machine, contact information associated with the receiving fax machine, and one or more groups or recipient lists associated with the receiving fax machine.

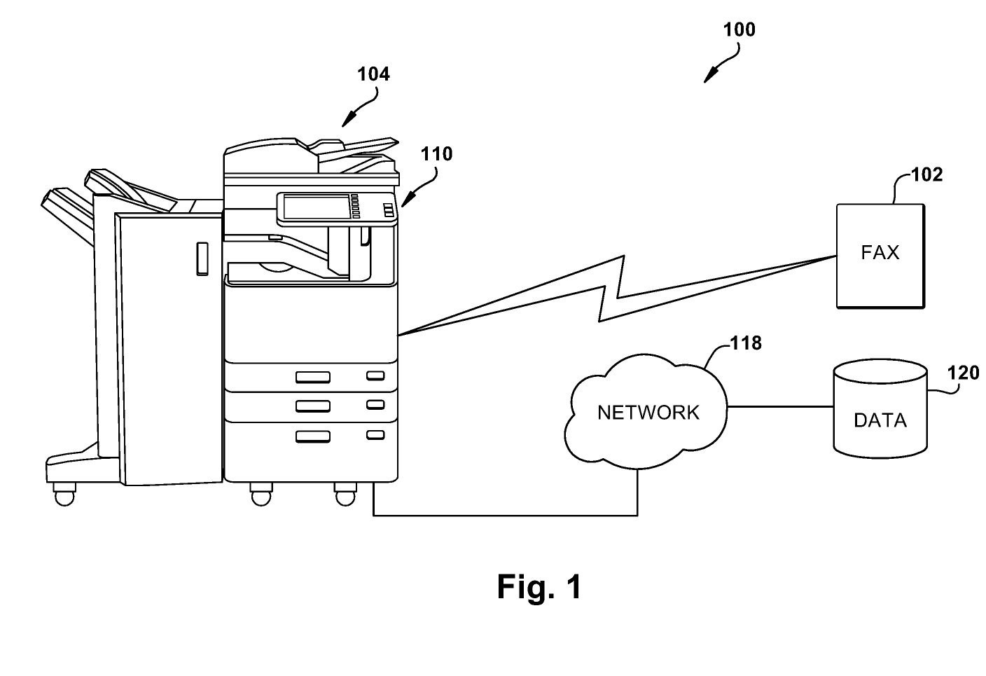

Referring to FIG. 1, illustrated is an example embodiment of a system 100 configured with a user interface for entry and selection of fax recipient information. While the example is directed to document processing devices, it will be appreciated that the methods described herein can be suitably implemented in connection with any device control interface. The system includes a multifunction peripheral or MFP 104, a network 118 such as a wired or wireless local area network, and a network accessible database or data store such as data store 120. The MFP 104 is configured to send faxes to remote fax machines, such as fax 102. The MFP 104 includes a user interface 110, suitably comprised of a panel including a display, such as a touchscreen display, switches, trackball, mouse or any other suitable human/device interface.

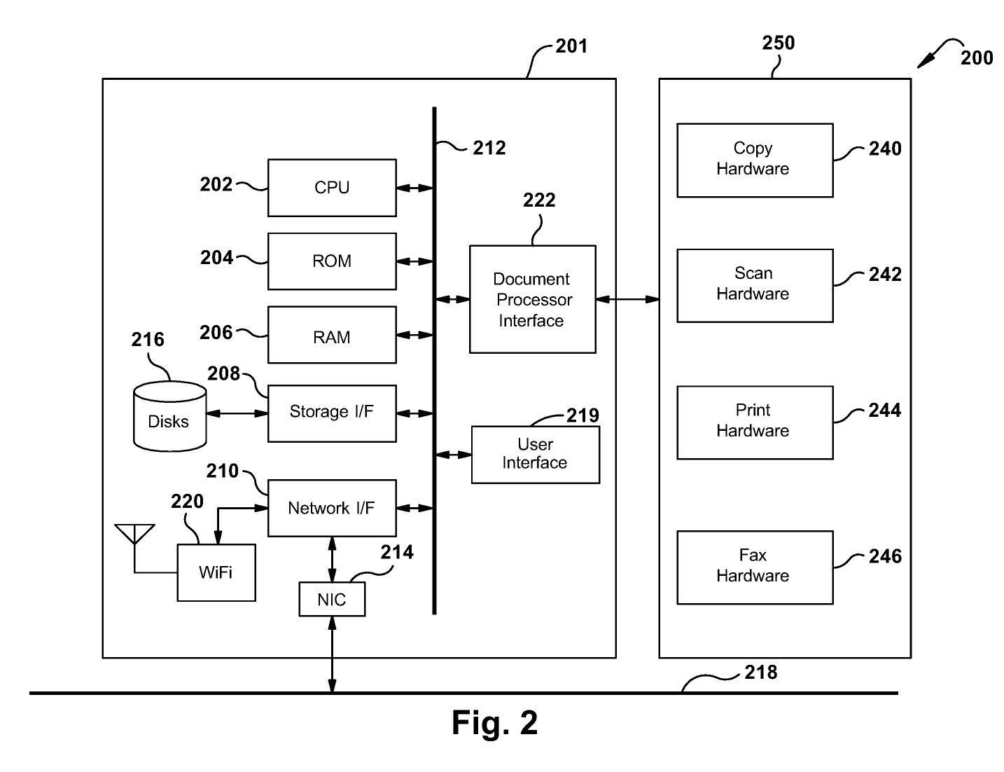

Turning now to FIG. 2, illustrated is an example embodiment of a document rendering system 200 suitably comprised within an MFP, such as with MFP 104 of FIG. 1. Included in controller 201 are one or more processors, such as that illustrated by processor 202. Each processor is suitably associated with non-volatile memory, such as ROM 204, and random access memory (RAM) 206, via a data bus 212. Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 218 or to a wireless data connection via wireless network interface 220. Example wireless connections include cellular, Wi-Fi, BLUETOOTH, NFC, wireless universal serial bus (wireless USB), satellite, and the like. Example wired interfaces include Ethernet, USB, IEEE 1394 (FireWire), LIGHTNING, telephone line, or the like.

Processor 202 can also be in data communication with any suitable user input/output (I/O) interface 219 which provides data communication with user peripherals, such as displays, keyboards, mice, track balls, touchscreens, or the like. Also in data communication with data bus 212 is a document processor interface 222 suitable for data communication with MFP functional units 250. In the illustrate example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

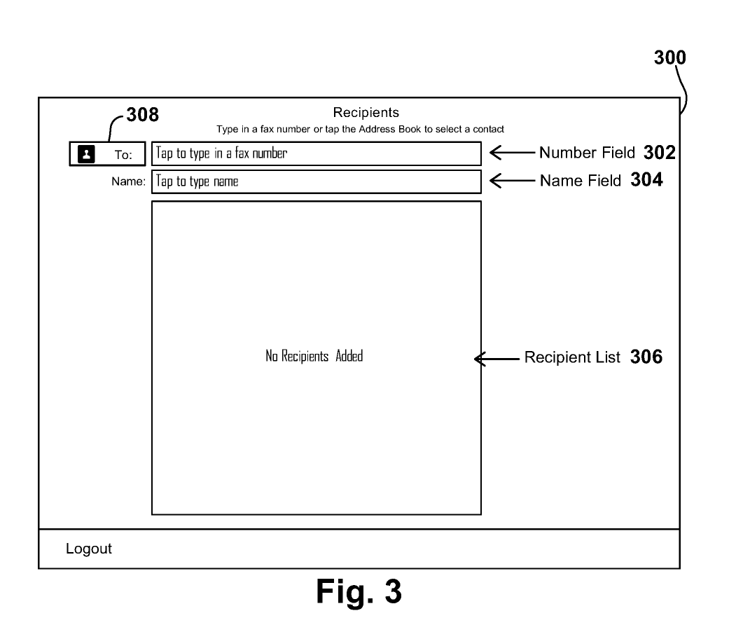

Turning next to FIGS. 3-11, illustrated are example embodiments of user interface screens for entering and selecting fax recipient information. FIG. 3 illustrates a touchscreen control panel 300. A user can type a telephone number of a fax recipient into the number field entry box 302. The user can type a name, or other alphanumeric identifying information, of the fax recipient into the name field entry box 304. The user can select an address book icon 308 to retrieve an address book of contacts. As the user enters or select fax recipients, the fax recipients are shown in a recipient list 306.

When the user enters a telephone number of a fax recipient into the number field entry box 302, the MFP determines if the entered number is associated with a contact in the address book. In a first configuration, the MFP can have a locally stored copy of contacts, for example the user's contacts, a list of company contacts, or a suitable combination of both. In a second configuration, the MFP can query a database, such as data store 120 of FIG. 1, for contact information.

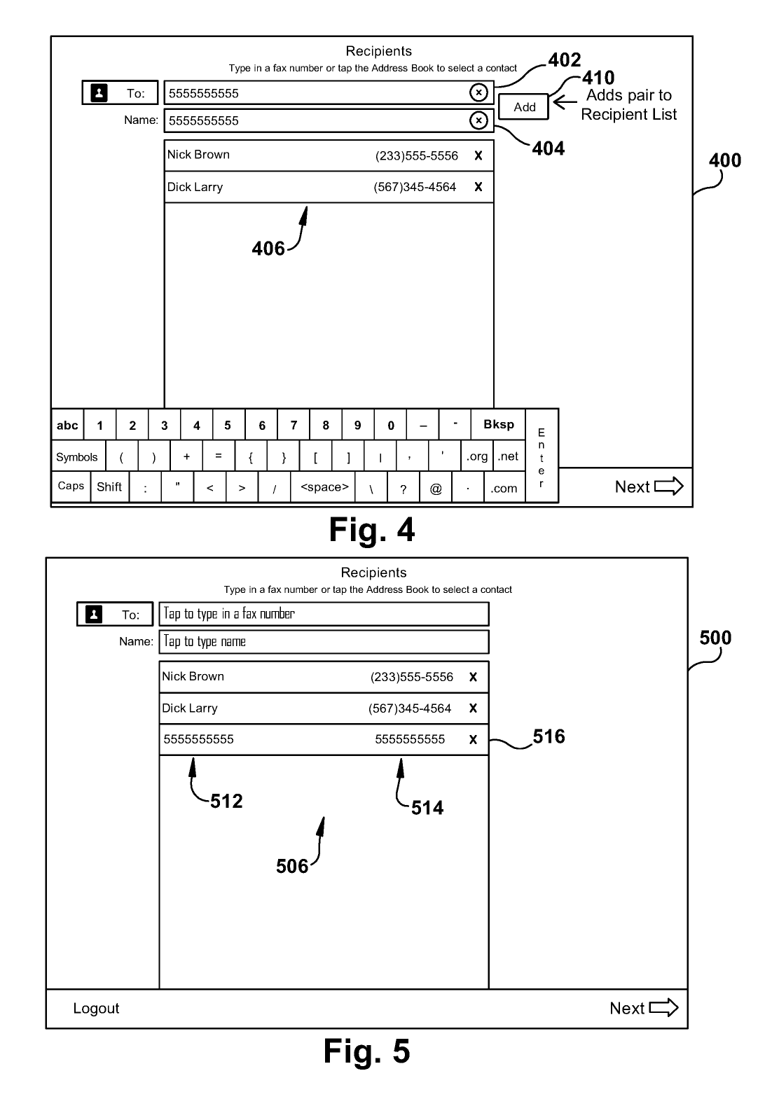

Referring now also to FIG. 4, if the MFP does not find any matching contact information for the entered number, then the MFP can take the number entered into the number field entry box 402 of the touchscreen control panel 400 and populate the name field entry box 304 with the entered number. The fax recipient in this instance is sometimes called an ad hoc recipient. The user can select the add selection button 410 to add the ad hoc recipient to the recipient list 406.

Referring now also to FIG. 5, if the user added the ad hoc recipient described in reference to FIG. 4, then the touchscreen control panel 500 can show an ad hoc recipient 516 in the recipient list 506 that includes the entered number as both the name 512 and the fax number 514 of the ad hoc recipient 516.

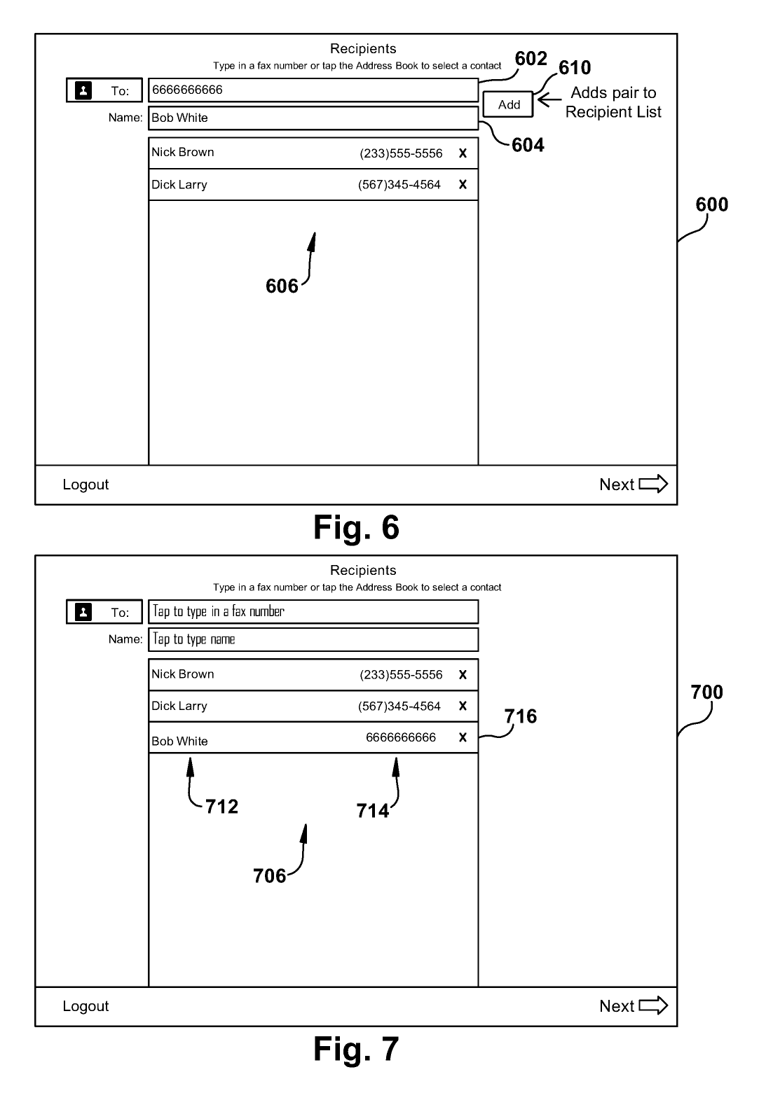

Referring back to FIG. 3, and now also referring to FIG. 6, if the MFP finds matching contact information for the number entered into the number field entry box 602 of touchscreen control panel 600, then the MFP can populate the name field entry box 604 with suitable contact information. For example, the MFP can enter the name of the recipient associated with the receiving fax machine number from the contact information. The user can select the add selection button 610 to add the new recipient, who is a known recipient, to the recipient list 606.

Referring now also to FIG. 7, if the user added the recipient described in reference to FIG. 6, then the touchscreen control panel 700 can show the known recipient 716 in the recipient list 706 that includes recipient's name 512, or other suitable contact information of the recipient, and the fax number 714 of the known recipient 716.

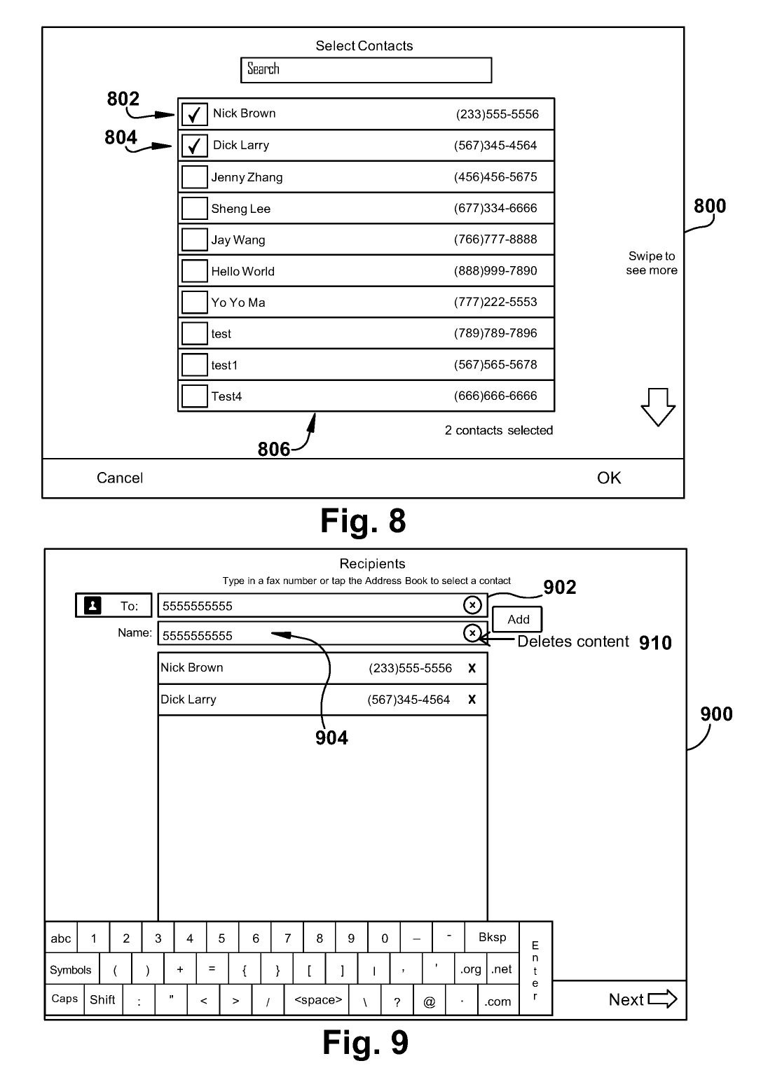

Referring back to FIG. 3, and now also referring to FIG. 8, if the user selected the address book icon 308 in reference to FIG. 3, then the touchscreen control panel 800 of FIG. 8 can show a list of contacts 806 that can be retrieved as described above. The user can select contacts, for example by toggling checkboxes of first contact 802 and second contact 804, that can be added to the fax recipient list described in reference to FIGS. 3-7 above.

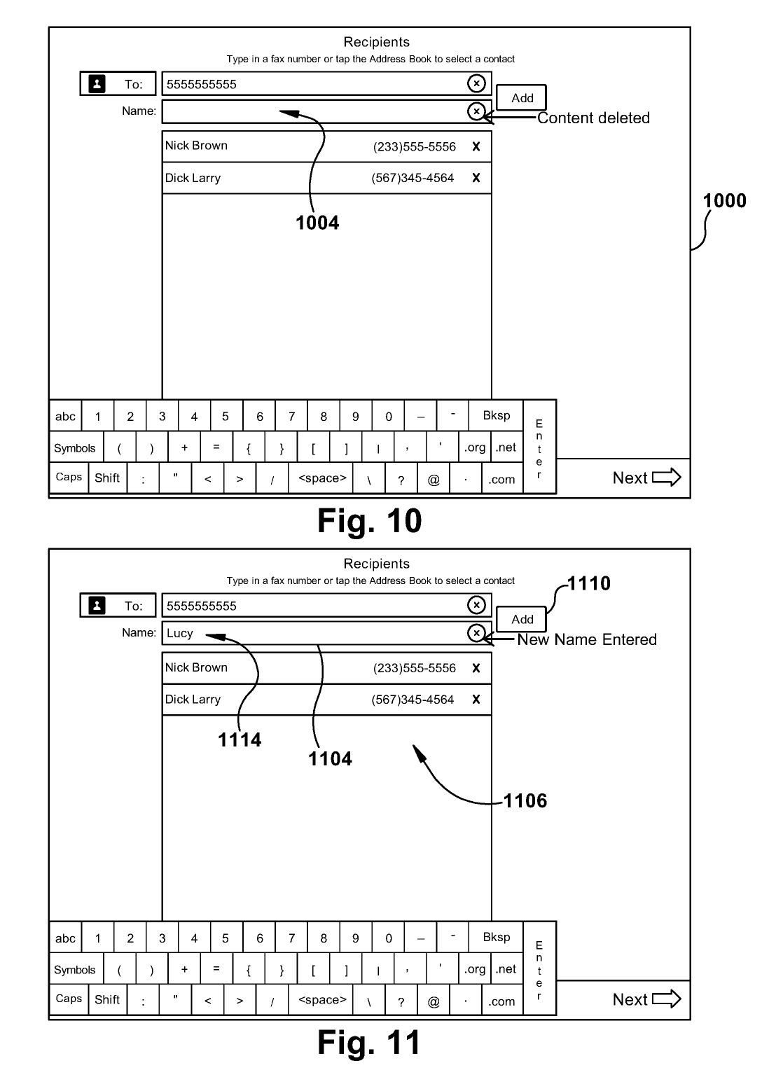

Referring to FIG. 9, in the illustrated touchscreen control panel 900, the user can modify the contact information in the name field entry box 904 populated by the MFP. For example, as illustrated in FIG. 9, if the MFP copied the fax number from the number field entry box 902 into the name field entry box 904, then the user can delete the populated information by pressing a delete content button 910. Referring now also to FIG. 10, in the illustrated touchscreen control panel 1000, the MFP can show an empty name field entry box 1004 as a result of the user deleting the populated information of FIG. 9. Referring now also to FIG. 11, in the illustrated touchscreen control panel 1100, the user can enter new alphanumeric text as overwritten contact information 1114 into the name field entry box 1104. The user can press the add selection button 1110 to add a recipient with overwritten contact information 1114 to the recipient list 1106.

In an embodiment, the overwritten contact information 1114 for the recipient is not written back to the address book or contact list by the MFP. Instead, the overwritten contact information is only used for the current recipient list 1106. This can be done for specific reasons. For example, when the fax number is retrieved by the MFP, the receiving fax machine may be identified in the address book as belonging to a particular company or a department in a company, and not the particular individual to which the user is sending the fax. Therefore, the user sending the fax may want to identify the particular recipient by name for the current fax being sent, but not want to change the entry in the address book. This scenario can be particularly important when the address book is not the user's own address book, but rather is an address book used by multiple people, for example an address book accessible by the MFP that is used by the entire company for whom the user works.

In another embodiment, the overwritten contact information can be used to update the address book, for example after prompting the user and receiving confirmation to overwrite the contact information in the address book. In another embodiment, the recipient list can be saved as a new or updated recipient list for future use by the user.

In an embodiment, once the user has entered or selected all of the fax recipients in the recipient list, the user can instruct the MFP to commence faxing the document to each of the fax recipients in the recipient list.

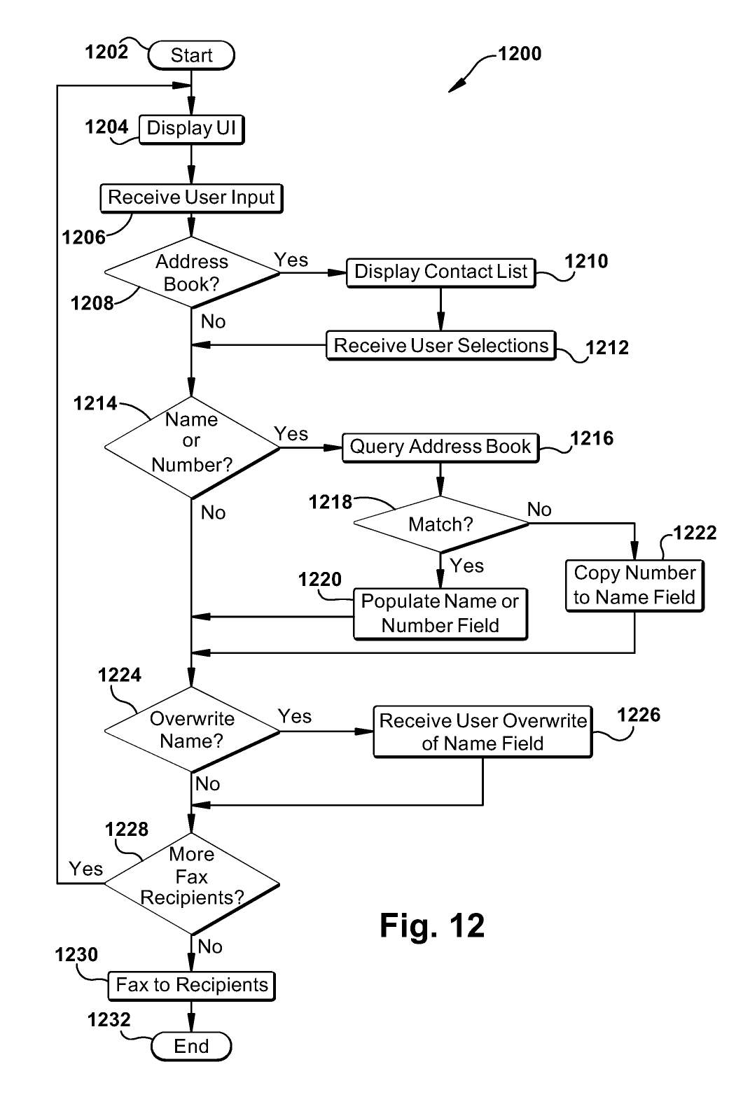

Referring now to FIG. 12, a flowchart 1200 of operations of an example MFP is illustrated. Operations starts at start block 1202 and proceeds to process block 1204.

In process block 1204, the MFP displays the user interface to the user. For example, the user can be presented with the user interface of FIG. 3 where the user can select an address book icon, or enter the recipient's name or fax number into one of the entry fields. The user interface can display a list of fax recipients. The list of fax recipients can initially be an empty list until the user adds fax recipients in process blocks 1206 through 1228. Processing proceeds to process block 1206.

In process block 1206, the MFP receives user input entered into the user interface by the user. Processing proceeds to decision block 1208.

In decision block 1208, if the user selected entering fax recipients from an address book, then processing continues to process block 1210, otherwise processing proceeds to decision block 1214.

In process block 1210, the MFP displays a list of contacts from the address book. For example, the address book can be the user's address book, a company address book, or an address book selected from a list of address books presented on the user interface of the MFP. The list of contacts can be a sorted list of names and fax numbers, or any suitable listing of contacts as would be understood in the art. The list of contacts can include groups of contacts, for example previously saved groups. Processing continues to process block 1212.

In process block 1212, the user interface of the MFP can receive the selection by the user of one or more contacts to add to the fax recipient list. For example, the user can click a selection box associated with each of the contacts to be added to the fax recipient list. The updated recipient list can be displayed by the user interface of the MFP in process block 1204. Processing continues to decision block 1214.

In decision block 1214, if the user entered information into entry fields in the user interface associated with either a contact name or fax number, then processing proceeds to process block 1216, otherwise processing continues to decision block 1224.

In process block 1216, the MFP can query one or more address books for contacts matching the information entered by the user into an entry field of the user interface. Querying can be performed by the MFP over the network to a remote database, or querying can be performed locally when the MFP has contact information stored in memory. In a configuration, querying can be performed both locally and with the remote database. Processing continues to decision block 1218.

In decision block 1218, if the MFP determines that there is a match between the information entered by the user and one or more of the contacts in an address book, then processing proceeds to process block 1220, otherwise processing proceeds to process block 1222.

In process block 1220, the MFP determined that there was a match between the information entered by the user and one or more of the contacts. For example, if the user entered a fax number, and the MFP found a matching contact having the same fax number, then the MFP can populate the name field with suitable information from the contact information, such as the name of the recipient. Similarly, if the user entered a contact name, and the MFP found a matching contact, then the MFP can enter the fax number from the contact information into the fax field of the user interface. In an embodiment, if the MFP determines that there are more than one matching contact for the information entered by the user, then the MFP can allow the user to select the desired contact (not shown), as would be understood in the art. Processing continues to decision block 1224.

In process block 1222, when the MFP cannot find a match for the information entered by the user, then the MFP can allow an ad hoc fax recipient to be added to the recipient list. If the user entered a fax number, then the MFP can copy the fax number into the name field. Processing continues to decision block 1224.

In decision block 1224, if the user overwrites the information entered into one of the entry fields of the user interface, then processing continues to process block 1226, otherwise processing continues to decision block 1228.

In process block 1226, the user deletes the information presented in one of the entry fields, for example the fax number entry field or the name entry field, and overwrites that information with new information. For example, the user may desire to update the name of the recipient that is to receive the fax at the fax machine associated with the entered fax number. Processing continues to decision block 1228.

In decision block 1228, if the user continues to add, select, or update the list of fax recipients in the recipient list, then processing continues back to process block 1204 where the updated recipient list is presented on the user interface of the MFP. Otherwise, if the user is done updating the recipient list, then processing continues to process block 1230.

In process block 1230, the MFP can fax the document to each of the recipients in the fax recipient list. Processing terminates at end block 1232.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a user interface including an input configured to receive fax recipient information and a display;
a memory configured to store a fax recipient list corresponding to the received fax recipient information; and
a processor configured to
generate a user interface screen on the display, the user interface screen including a list of fax recipients, a fax number entry field, and a name entry field,
monitor user input of fax recipient information via the user interface,
determine if the fax recipient information at least partially matches information associated with a contact in an address book,
populate at least one of the fax number field or the name field using contact information associated with a matching contact only when there is at least a partial match,
populate the name field using a fax number entered by a user into the fax number entry field only when there is no match of the fax number with a contact,
add a fax recipient to the list of fax recipients using the information in the fax number entry field and the name entry field, and
complete a document processing operation in accordance with instructions received from the user and using the list of fax recipients.

2. The system of claim 1, wherein the document processing operation includes faxing a document to each fax recipient in the list of fax recipients.

3. The system of claim 1, wherein the processor is further configured to display the list of fax recipients on the user interface screen.

4. The system of claim 1, wherein the processor is further configured to query an address book using the received fax recipient information.

5. The system of claim 4, wherein the address book information is stored in a networked database, and wherein the query is performed across a network.

6. The system of claim 4, wherein the address book is stored in the memory.

7. The system of claim 1, wherein the processor is further configured to
display a selectable list of contacts from the address book via the user interface,
monitor user input for selection of one or more contacts from the list of contacts via the user interface, and
add one or more fax recipients to the list of fax recipients based on one or more user selections.

8. The system of claim 1, wherein the processor is further configured to
monitor user input for overwriting the populated information in at least one of the fax number field or the name field, and
wherein the fax recipient added to the list of fax recipients is based at least in part on overwritten information.

9. The system of claim 1, wherein the processor is further configured to
monitor user input for a command to add a fax recipient to the list of fax recipients, and
wherein the fax recipient is added to the list of fax recipients in response to the command.

10. A method comprising:
generating a user interface on a display of a multifunction peripheral device, the user interface including a list of fax recipients, a fax number entry field, and a name entry field;
monitoring an input associated with the user interface of the multifunction peripheral device for user input of fax recipient information into at least one of the fax number entry field or the name entry field;
determining if the fax recipient information at least partially matches information associated with a contact in an address book;
populating at least one of the fax number field or the name field using contact information associated with a matching contact only when there is at least a partial match;
populating the name field using a fax number from the fax number entry field only when there is no match of the fax number with information associated with a contact in the address book;
adding a fax recipient to the list of fax recipients using the information in the fax number entry field and the name entry field; and
completing a document processing operation, by the multifunction peripheral device, in accordance with instructions received from the user and using the list of fax recipients.

11. The method of claim 10, wherein the document processing operation further comprises faxing a document to each fax recipient in the list of fax recipients.

12. The method of claim 10, further comprising displaying the list of fax recipients in the user interface on the display.

13. The method of claim 10, further comprising querying one or more of a network connected database associated with the address book, or an address book stored in a memory of the multifunction peripheral device.

14. The method of claim 10, further comprising:
displaying, via the user interface, a selectable list of contacts from the address book;
monitoring the input associated with the user interface of the multifunction peripheral device for user selection of one or more contacts from the list of contacts; and
adding one or more fax recipients to the list of fax recipients based on one or more user selections.

15. The method of claim 10, further comprising:
monitoring the input associated with the user interface of the multifunction peripheral device for user overwriting of the populated information in at least one of the fax number field or the name field, and
wherein the fax recipient added to the list of fax recipients is based at least in part on overwritten information.

16. The method of claim 10, further comprising:
monitoring the input associated with the user interface of the multifunction peripheral device for a user command to add a fax recipient to the list of fax recipients, and
wherein the fax recipient added to the list of fax recipients in response to the user command.

17. A document processing device, comprising:
a device controller including a processor and memory; and
a touchscreen display configured to present a user interface and receive user input,
wherein the processor is configured to generate a user interface screen for display on the touchscreen display that includes a list of fax recipients, a fax number entry field, and a name entry field,
wherein the processor is further configured to receive fax recipient information input by a user via the touchscreen display and display the received fax recipient information in one of the fax number entry field or the name entry field,
wherein the processor is further configured determine if the received fax recipient information at least partially matches one or more contacts, and
when there is at least a partial match, populate at least one of the fax number field or the name field using contact information associated with a contact, and
when there is no match of a fax number in the fax number entry field with one or more contacts, populate the name field using the fax number,
wherein the processor is further configured to add a fax recipient to the list of fax recipients using information in the fax number entry field and name entry field, and
wherein the processor is further configured to fax a document to each fax recipient in the fax recipient list.

18. The document processing device of claim 17, wherein the processor is further configured to generate a user interface screen including a selectable list of contacts,
wherein the processor is further configured to monitor the touchscreen display for user selection of one or more contacts from the list of contacts, and
wherein the processor is further configured to add one or more fax recipients to the list of fax recipients based on the one or more user selections.

19. The document processing device of claim 17, wherein the processor is further configured to monitor the touchscreen display for user input that overwrites information in at least one of the fax number field or the name field,
wherein the fax recipient is added to the list of fax recipients and that includes the user input that overwrote the information in at least one of the fax number field or the name field.

20. The document processing device of claim 17, wherein the processor is further configured to monitor the touchscreen display for a user command to add a fax recipient to the list of fax recipients, and
wherein the fax recipient is added to the list of fax recipients only in response to the user command.
